(19) United States
(12) Patent Application Publication
(10) Pub. No.: US 2015/0224579 A1
(43) Pub. Date: Aug. 13, 2015

(54) Metal Mold Manufacturing Method

(71) Applicants: Hiroyuki Matsuda, Chiyoda-ku (JP); Gorou Arahi, Chiyoda-ku (JP); Hidenori Ando, Chiyoda-ku (JP)

(72) Inventors: Hiroyuki Matsuda, Chiyoda-ku (JP); Gorou Arahi, Chiyoda-ku (JP); Hidenori Ando, Chiyoda-ku (JP)

(73) Assignee: Konica Minolta, Inc., Tokyo (JP)

(21) Appl. No.: 13/882,723

(22) PCT Filed: Dec. 8, 2012
(86) PCT No.: PCT/JP2012/081861

§ 371 Date: Apr. 30, 2013

(30) Foreign Application Priority Data
Dec. 19, 2011 (JP) 2011-277180
Oct. 19, 2012 (JP) 2012-231365

(51) Int. Cl. B23B 5/36; C03B 11/06

(52) U.S. Cl. CPC B23B 5/36; C03B 11/06; C03B 2215/06

(57) ABSTRACT

A metal mold manufacturing method is provided, which is capable of forming a metal mold having a plurality of transfer surfaces with positions of optical axes being different by a lathe at high accuracy. An n-th (n is an integer of 1 to 4) side surface SDn of a material 1 of the metal mold abuts against an X-axis directional reference plane 2b of a jig 2, an (n+1)th side surface (but n=1 when n is 4) of a material 1′ of the metal mold abuts against a Y-axis directional reference plane 2c of the jig 2, and the material 1 of the metal mold is thus fixed to the jig 2. Subsequently, the n-th transfer surface is formed by cutting the material 1′ of the metal mold while rotating the jig 2 and the material 1 of the metal mold together by a lathe. Thereafter, the steps are repeated in a way that raises n by one.

### TECHNICAL FIELD

The present invention relates to a metal mold manufacturing method suited for transfer-forming optical element.

A compact and very thin image capturing apparatus (which will hereinafter be referred to also as a camera module) is used for a portable terminal like a mobile phone, a PDA (Personal Digital Assistant) and a smartphone each defined as a compact and thin electronic device such as a cellular phone and the PDA. A solid-state image capturing element such as a CCD (Charge Coupled Device) image sensor and a CMOS (Complementary Metal Oxide Semiconductor) image sensor is known as an image capturing element used for the image capturing apparatus. Over the recent years, a progression of enhancement of pixels (higher definition) of the image capturing element has been underway, in which a resolution and performance have been contrived to increase. Further, an image-capturing lens for forming an image of a subject on the image capturing device has been requested to attain compactness corresponding to downsizing of the image capturing element, and this request has tended to be raised year after year.

A known method of manufacturing the image-capturing lens used for the image capturing apparatus built in the portable terminal described above is that the image-capturing lens is, as described in Patent document 1, manufactured by molding glass lens arrays configured by connecting a plurality of lenses from, e.g., glasses by use of metal molds, optical axes of the lenses are aligned by the benchmark of simultaneously molded ribs, thereafter pasting a pair of glass lens arrays, and cutting out the glass lens arrays on a per-lens basis.

### DOCUMENT OF PRIOR ART

### Patent Document

Patent document 1: International Publication WO2011/093502

### DISCLOSURE OF INVENTION

### Problems to be Solved by Invention

According to the Patent document 1, the optical axes of the plurality of lenses can be aligned at high accuracy by the benchmark of the ribs of the glass lens arrays. By the way, if the optical axis of the optical surface on an object side and the optical axis of the optical surface on an image side that are formed on the glass lens array are not positioned (not aligned), the lens exhibiting an excellent optical characteristic cannot be acquired. Nevertheless, the metal mold having a transfer surface corresponding to the object-side optical surface is separate from the metal mold having a transfer surface corresponding to the image-side optical surface, and hence, if an optical axis pitch of the transfer surface of the different metal mold is different, it follows that a deviation occurs in the optical axes of both surfaces of any one of the lenses. Namely, it is of importance to position at the high accuracy the transfer surfaces for transfer-forming the lenses in the individual metal molds for molding the glass lens arrays.

Herein, in the case of lathe-turning and thus forming the transfer surfaces of the metal mold, it is desirable that the optical axis of the transfer surface to be formed is positioned just on the Z-axis defined as the axis of rotation of a chuck of the lathe. Such being the case, it is considered that a jig for retaining a material of the metal mold on the chuck is formed with abutting surfaces for positioning in X- and Y-axis directions orthogonal to the Z-axis, and the transfer surface is lathe-turned by positioning a different portion on the Z-axis while varying a thickness of a spacer inserted in between the material of the metal mold and the abutting surface. In such a method, however, the following problems are predicted.

The method of inserting the spacer in between the material of the metal mold and the abutting surface causes a problem that an addition of error factors (dusts being caught in, an error of a shift quantity due to a dimensional error of a thickness of the spacer, occurrence of inclination of the material of the metal mold due to an error of parallelism between both surfaces of the spacer, etc) due to an increase in number of contact surfaces, facilitates occurrence of an error of position of the optical axis of the transfer surface and makes it difficult to ensure accuracy of a stable working position in the case of working a multiplicity of metal molds. Moreover, such problems also arise as to cause a rise in cost of the jigs due to an increase in number of jig components and as to get management complicated.

In contrast with this, it is considered that the multiple surfaces are worked without removing the material of the metal mold from a multi-axis working machine by NC-controlling a tool position with respect to the material of the metal mold by use of the multi-axis working machine. This contrivance can eliminate the error factor due to attaching and detaching the material of the metal mold. Generally, the work, which involves using the multi-axis working machine, however, has problems such as getting easy to deteriorate roughness of the working surface, to elongate a period of working time and to undergo a restriction of work materials as compared with the work by the lathe.

It is an object of the present invention, which was devised in view of the problems inherent in the prior arts described above, to provide a metal mold manufacturing method capable of forming at high accuracy a metal mold having a plurality of transfer surfaces of which optical-axis positions are different by use of a lathe.

### Solution to Problems

A metal mold manufacturing method according to claim 1 is a method of work-forming a plurality of transfer surfaces corresponding to optical surfaces of an optical element by use of a lathe on a material of a metal mold with its external shape being an equilateral N-angle shape (N is an even number equal to or larger than “4”), the material being fitted to a jig including a first reference plane parallel with an axis of rotation of the lathe and a second reference plane parallel with the axis of rotation and extending in a direction intersecting the first reference plane, the method including:

a first step of getting an n-th (n is an integer equal to or larger than “1”) side surface of the material of the metal mold to abut against the first reference plane of the jig, getting a (n+k)th (k is an integer equal to or larger than “1”) side surface of the material of the metal mold to abut against the second reference plane of the jig, and thus fixing the material of the metal mold to the jig;

a second step of forming the transfer surface by cutting the material of the metal mold while rotating the jig and the material of the metal mold together by the lathe; and

a third step of forming other transfer surfaces by repeating the first step and the second step in a way that raises the number of n.

Herein, the phrase “its external shape being an equilateral N-angle shape” embraces, in addition to a perfect equilateral N-angle shape, a case where a shape formed by getting extended surfaces to intersect each other, into which to extend the side surfaces abutting against the reference plane of the jig, is the equilateral N-angle shape. In the latter case, the surfaces other than the side surfaces abutting against the reference plane of the jig may be flat surfaces (rectilinear shapes) or curved surfaces (circular arc shapes) and further include surfaces each provided with a chamfer between the adjacent side surfaces. Moreover, “the n-th side surface” corresponds to the n-th side surface when counting, if a certain side surface is set as the first side surface, the side surfaces clockwise or counterclockwise about the axis of rotation of the lathe. When n>N, however, an (n−N)th side surface is applied.

To be specific, such a case is considered that when N=4, n=1 and k=1, four transfer surfaces are formed on the material of an equilateral quadrangular metal mold. To start with, the first side surface (that is an arbitrary side surface from which to count the side surfaces clockwise or counterclockwise) of the material of the metal mold is made to abut against the first reference plane of the jig, and further the second side surface of the material of the metal mold is made to abut against the second reference plane of the jig, thereby fixing the material of the metal mold to the jig (the first step). Moreover, the first transfer surface is formed by cutting the material of the metal mold while rotating the jig and the material of the metal mold together by use of the lathe (the second step). Thereafter, the material of the metal mold is removed from the jig and rotated through 90 degrees (namely, a value of n is raised by one), and the second side surface of the material of the metal mold is made to abut against the first reference plane of the jig, further the third side surface of the material of the metal mold is made to abut against the second reference plane of the jig, thereby fixing the material of the metal mold to the jig (the first step). Moreover, the next transfer surface is formed by cutting the material of the metal mold while rotating the jig and the material of the metal mold together by use of the lathe (the second step). What is described above corresponds to the third step. The lathe-turning process is thus repeated four times, whereby the four transfer surfaces are formed on the material of the metal mold. The following effects are acquired from the above processes derived by the present inventors.

(1) Since a spacer or the like is not interposed between the reference plane of the jig and the metal mold, error factors causing a deviation of the optical axis of the transfer can be reduced, and, in addition to improvement of positional accuracy of the optical axis with respect to a design value in one single metal mold, it is feasible to manufacture the metal having the position of the transfer surface that is stable irrespective of the error of the metal mold even on the occasion of working a multiplicity of metal molds because of reproducibility being preferable.

(2) As a result, when mold-working the lens array including the plurality of lenses by employing a pair of metal molds worked by this method, it becomes easy to simultaneously align the optical axes of the object-side optical surface and the image-side optical surface of each lens. Moreover, also in the case of simultaneously forming a plurality of lens units each containing two lens elements by use of four metal molds, the optical axes of the four optical surfaces of each lens unit can be aligned.

The metal mold manufacturing method according to claim 2, in the invention according to claim 1, is characterized in that an optical axis of the first transfer surface to be work-formed at first shifts from a bisection of the first reference plane and the second reference plane of the jig, passes through a center of the equilateral N-angle shape and exists on a line orthogonal to the bisector.

With this contrivance, even when the external dimension of the material of the metal mold has an error from a design value, an inter-optical-axis pitch of the transfer surface to be worked can be hardly affected. According to the results of the examinations of the present inventors, it was understood that the present invention could restrain the error of the optical-axis pitch down to ⅓ or under of the error in the prior arts.

The metal mold manufacturing method according to claim 3, in the invention according to claim 1, is characterized in that an optical axis of the first transfer surface to be work-formed at first shifts from a bisection of the first reference plane and the second reference plane of the jig, passes through a center of the equilateral N-angle shape and exists on a line orthogonal to the bisector.

The optical axis can be thereby positioned at the high accuracy with respect to the side surfaces of the metal mold. That is, it is possible to select which error, the error of the optical-axis pitch of the transfer surface or the error of the rotational component with respect to the reference plane, is emphasized based on choosing what position the transfer surface is worked in with respect to the reference plane of the jig.

The metal mold manufacturing method according to claim 4, in the invention according to any one of claims 1 to 3, is characterized in that N=4, and k=1.

The metal mold manufacturing method according to claim 5, in the invention according to any one of claims 1 to 3, is characterized in that N=8, and k=2. However, N may also be an integer that is equal to or larger 6 or 8.

The metal mold manufacturing method according to claim 6, in the invention according to any one of claims 1 to 5, is characterized in that an error of an external dimension of the metal mold is equal to or smaller than ½of an error of a distance between the plurality of transfer surfaces.

With this contrivance, the transfer surface can be worked stably within the error of the distance between the desired transfer surfaces.

The metal mold manufacturing method according to claim 7, in the invention according to any one of claims 2, 4 to 6, is characterized in that when manufacturing the first metal mold and the second metal mold having a face-to-face relationship with the first metal mold by the manufacturing method, a tolerance of accuracy of the external dimension of the first metal mold is set minus, while the tolerance of accuracy of the external dimension of the second metal mold is set plus.

On the occasion of combining the first metal mold and the second metal mold together, a smaller amount of adjustment may be sufficient for combining the metal molds together when the center of the transfer surface rotates in the same direction with respect to the design position. Namely, if a tolerance of the accuracy of the external dimension of the first metal mold is set minus and if the tolerance of the accuracy of the external dimension of the second metal mold is set plus, the direction in which the center of the transfer surface rotates with respect to the design position is reversed in a case where the error of the external dimension occurs respectively, and hence the worked transfer surfaces get close to each other when combining the first metal mold and the second metal mold together, thereby facilitating the adjustment. Note that “the tolerance being plus” implies a case in which the error is plus with respect to the design dimension (which means that the actual dimension is equal to or larger than the design dimension), while “the tolerance being minus” implies a case in which the error is minus with respect to the design dimension (which means that the actual dimension is equal to or smaller than the design dimension).

The metal mold manufacturing method according to claim 8, in the invention according to claim 7, is characterized in that an absolute value of the error of the external dimension of the first metal mold is approximately equal to an absolute value of the error of the external dimension of the second metal mold.

With this contrivance, when combining the first metal mold and the second metal mold together, the worked transfer surfaces get much closer to each other, thereby further facilitating the adjustment.

### Effects of Invention

According to the present invention, it is feasible to provide the metal mold manufacturing method capable of forming at high accuracy the metal mold having the plurality of transfer surfaces of which the optical-axis positions are different by use of the lathe.

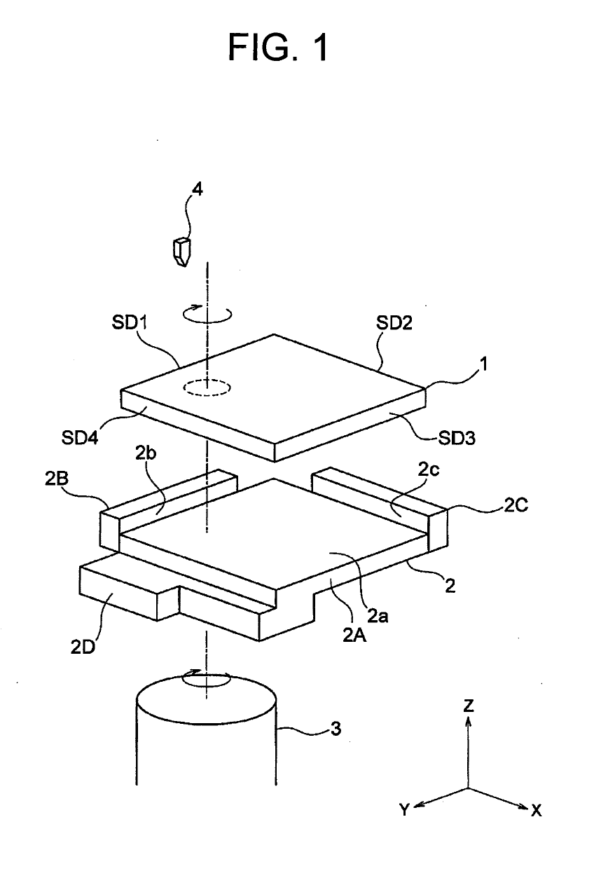

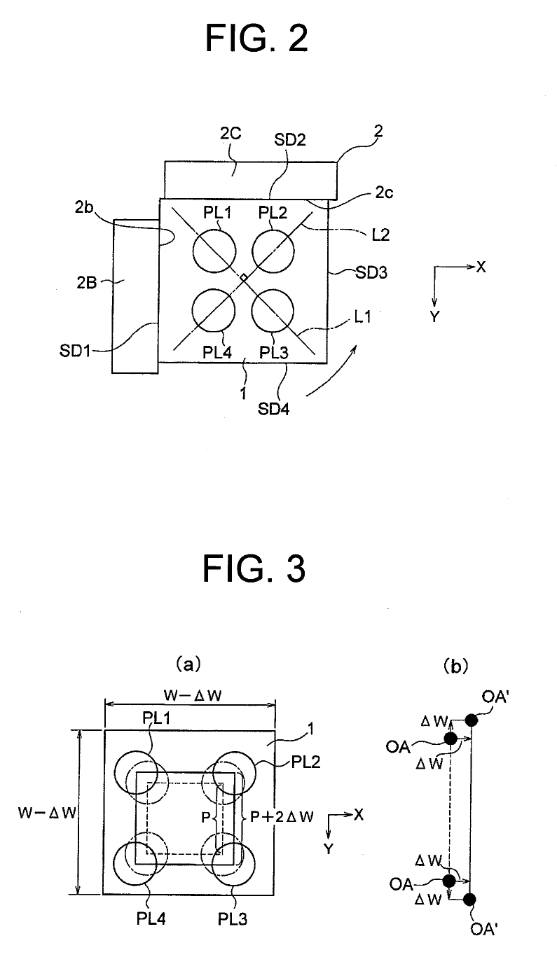

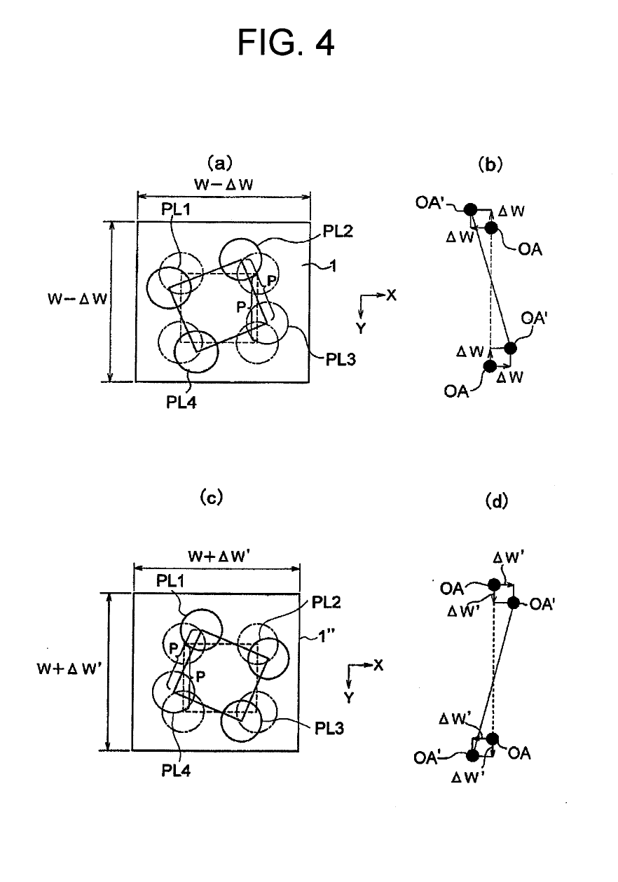

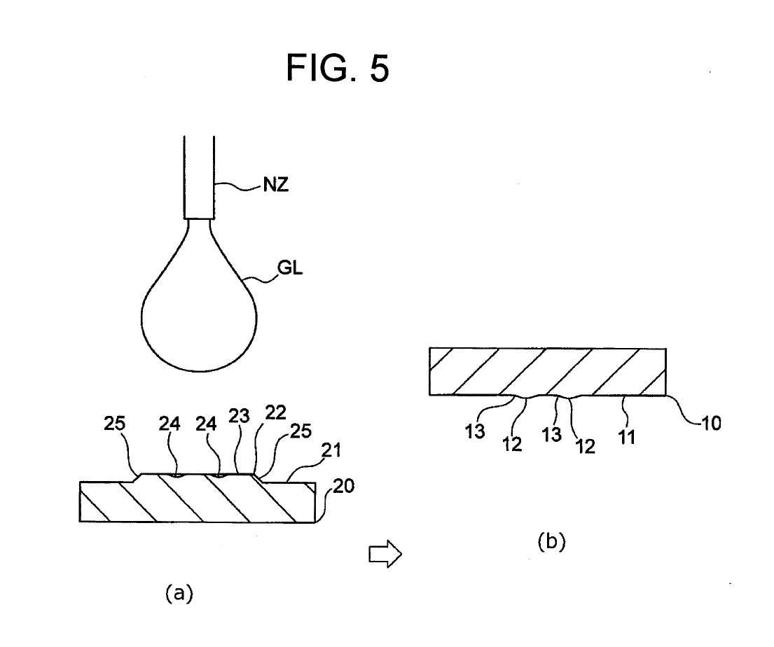

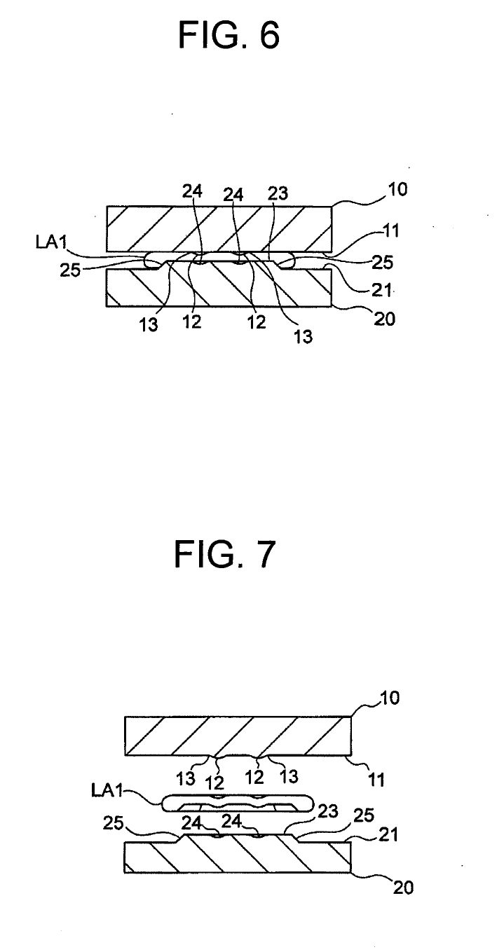

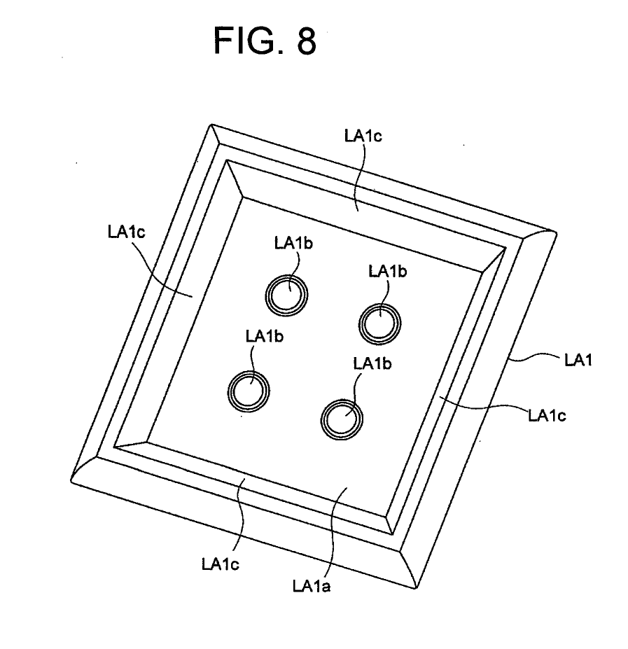

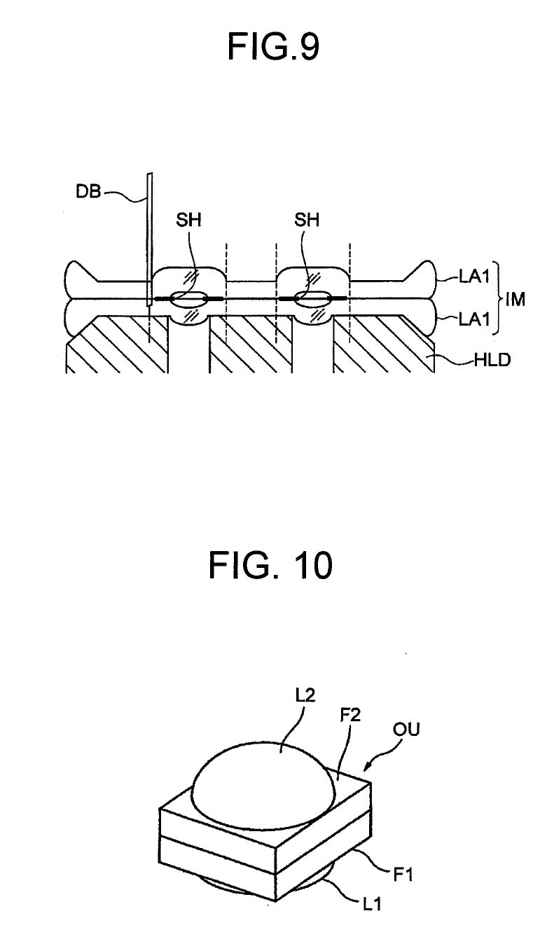

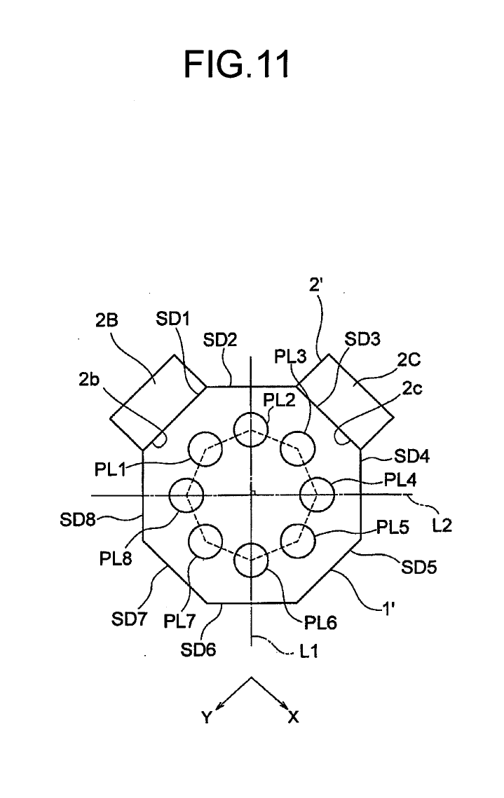

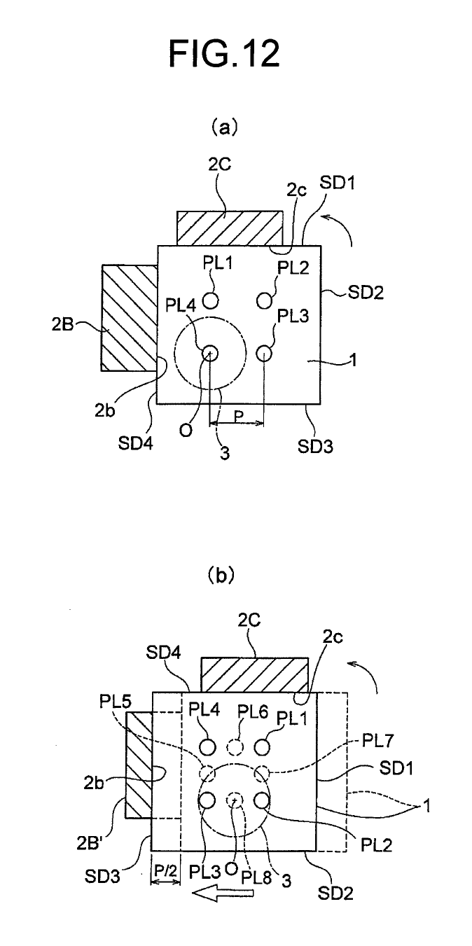

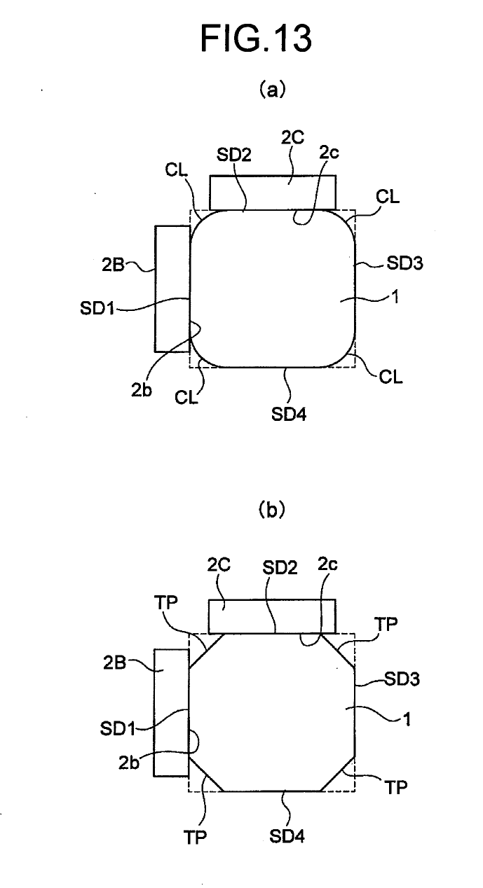

### BRIEF DESCRIPTION OF THE DRAWINGS

[FIG. 1] A perspective view illustrating a state of how a metal mold of an optical element is worked.

[FIG. 2] A view depicting a state of retaining a material 1 of a metal mold 1 by a jig 2 as viewed along a direction of a Z-axis.

[FIG. 3] A view illustrating a first mode; FIG. 3(a) is a view schematically depicting a worked surface of the material 1 of the metal mold, in which one dotted chain line indicates a transfer surface based on a design value, while a solid line indicates the transfer surface that is actually lathe-turned; and FIG. 3(b) is a view schematically illustrating a shift direction of an optical axis of the transfer surface.

[FIG. 4] A view illustrating a second mode; FIG. 4(a) is a view schematically depicting the worked surface of the material 1 of the metal mold, in which the one dotted chain line indicates the transfer surface based on the design value, while the solid line indicates the transfer surface that is actually lathe-turned; FIG. 4(b) is a view schematically illustrating the shift direction of the optical axis of the transfer surface; FIG. 4(c) is a view schematically depicting the worked surface of a material 1″ of the metal mold with a tolerance of an external dimension being reversed, in which the one dotted chain line indicates the transfer surface based on the design value, while the solid line indicates the transfer surface that is actually lathe-turned; and FIG. 4(d) is a view schematically illustrating the shift direction of the optical axis of the transfer surface.

[FIG. 5] A view depicting steps of molding a lens array used in the present embodiment by employing a metal mold; FIG. 5(a) is a view illustrating a state where a droplet of (molten) glass is about to be dropped down to a lower metal mold 20; and FIG. 5(b) is a view illustrating an upper metal mold 10.

[FIG. 6] A view depicting the steps of molding the lens array used in the present embodiment by employing the metal mold and depicting a state of its being molded by the metal mold.

[FIG. 7] A view depicting the steps of molding the lens array used in the present embodiment by employing the metal mold and depicting a state after a mold release.

[FIG. 8] A perspective view of a glass lens array LA1 that is transfer-formed by the upper metal mold 10 and the lower metal mold 20.

[FIG. 9] An enlarged sectional view of a state in which the glass lens array LA1 is held by a holder HLD.

[FIG. 10] A perspective view of an image-capturing lens acquired from an intermediate product IM.

[FIG. 11] A view depicting the state of retaining a material 1′ of the metal mold according to another embodiment by a jig 2′ as viewed along the direction of the Z-axis.

[FIG. 12] An explanatory view of a metal mold manufacturing method according to still another embodiment.

[FIG. 13] A front view depicting a modified example of the material of the metal mold.

### EMBODIMENT FOR CARRYING OUT THE INVENTION

Embodiments of the present invention will hereinafter be described with reference to the drawings. FIG. 1 is a perspective view depicting a state of how a metal mold of an optical element is worked. In FIG. 1, a Z-axis corresponds to an axis of rotation of a rotary shaft 3 of a lathe, an X-axis corresponds to a direction orthogonal to the Z-axis, and a Y-axis corresponds to a direction orthogonal to the Z-axis and the X-axis.

A material 1 of the metal mold is a square plate (N=4) configured with its side surfaces being orthogonal to each other at high accuracy. A jig 2 for retaining the material 1 of the metal mold is configured to include: a body 2A; an X-axis block 2B having an abutting surface (a first reference plane) 2b as a highly accurate flat surface fixed to the body 2A and orthogonal to the X-axis; a Y-axis block 2C having an abutting surface (a second reference plane) 2c as a highly accurate flat surface fixed to the body 2A and orthogonal to the Y-axis; and a balancer 2D protruding in the direction orthogonal to the Z-axis from the body 2A, in which these components may be, though integrally formed, assembled from a plurality of parts. It is preferable that the abutting surface 2b is spaced away from the abutting surface 2c. Further, the body 2A includes a retaining surface 2a defined as a flat surface in parallel with the X-axis and the Y-axis.

A mode (embodiment) of work-forming a plurality (which is herein “four”) of transfer surfaces corresponding to optical surfaces of the optical element on the surface of the material 1 of the metal mold, will be described. To start with, as illustrated in FIG. 1, the center of the body 2A of the jig 2 is shifted from the Z-axis, in which state the jig 2 is fixed onto a rotary shaft 3 of the lathe. In such a state, the undersurface of the material 1 of the metal mold is made to abut against the retaining surface 2A of the body 2A, further a side surface SD1 (which is defined as a first side surface) of the material 1 of the metal mold is made to abut against an abutting surface 2b of the X-axis block 2B, and a side surface SD2 (which is defined as a second side surface) of the material 1 of the metal mold is made to abut against the abutting surface 2c of the Y-axis block 2C, whereby the jig 2 retains the material 1 of the metal mold by use of an unillustrated fixing tool (a first step).

When rotating the rotary shaft 3 of the lathe from such a state, the material 1 of the metal mold rotates together with the jig 2, and hence a first transfer surface as indicated by a dotted line can be lathe-turned in a way that makes a turning tool 4 close to the surface of the material 1 of the metal mold (a second step). At this time, there is the balancer 2D, and it follows that a center of combined gravities of the material of the metal mold and the jig 2 is positioned in the vicinity of the Z-axis, whereby the stable lathe-turning can be conducted while restraining centrifugal whirling of the rotary shaft 3.

After finishing the lathe-turning of one transfer surface, the material 1 of the metal mold is removed from the jig 2 and rotated counterclockwise (or clockwise) through 90 degrees, the undersurface of the material 1 of the metal mold is thereafter again made to abut against the retaining surface 2a of the body 2A, the side surface SD2 of the material 1 of the metal mold is further made to abut against the abutting surface 2b of the X-axis block 2B, and a side surface SD3 (which is defined as a third side surface) of the material 1 of the metal mold is made to abut against the abutting surface 2c of the Y-axis block 2C, whereby the material 1 of the metal mold is retained on the jig 2 by use of the unillustrated fixing tool.

When rotating the rotary shaft 3 of the lathe from such a state, the material 1 of the metal mold rotates together with the jig 2, and hence the second transfer surface can be lathe-turned by making the turning tool 4 close to the surface of the material 1 of the metal mold (a third step).

After the second transfer surface has been lathe-turned, the material 1 of the metal mold is similarly rotated counterclockwise, the side surface SD3 of the material 1 of the metal mold is made to abut against the abutting surface 2b of the X-axis block 2B, and a side surface SD4 (which is defined as a fourth side surface) of the material 1 of the metal mold is made to abut against the abutting surface 2c of the Y-axis block 2C, thereby enabling the third transfer surface to be lathe-turned.

Further, after the third transfer surface has been lathe-turned, the material 1 of the metal mold is similarly rotated counterclockwise, the side surface SD4 of the material 1 of the metal mold is made to abut against the abutting surface 2b of the X-axis block 2B, and the side surface SD1 of the material 1 of the metal mold is made to abut against the abutting surface 2c of the Y-axis block 2C, thereby enabling the fourth transfer surface to be lathe-turned. Through the operations described above, the four transfer surfaces are completely lathe-turned.

Herein, a position for the lathe-turning will be considered. FIG. 2 is a view depicting a state of retaining the material 1 of the metal mold by the jig 2 as viewed along the direction of the Z-axis. A line L1 is a bisector of the abutting surfaces 2b, 2c orthogonal to each other, and a line L2 is a line orthogonal to the bisector. An effect differs depending on which line, the line L1 or the line L2, intersects the Z-axis. A specific description thereof will be made.

(First Working Mode)

FIG. 3(a) is a view schematically depicting a worked surface of the material 1 of the metal mold, in which a deviation of the transfer surface is illustrated in exaggeration. If an external dimension W of the material 1 of the metal mold is as indicated by a design value, it follows that a pitch P of each of an optical axis of the transfer surfaces PL1 to PL4 is formed as the design value indicates (see a one-dotted chain line). In this connection, an assumption is that the external dimension is smaller than the design value W, that is, (W−ΔW). The error ΔW is set, it is desirable, equal to or smaller than ½ of an inter-optical-axis allowable error of the transfer surfaces. With this contrivance, not only the distance between the optical axes but also absolute positional accuracy of the transfer surface with respect to the reference plane of the metal mold can be well maintained.

The two side surfaces among the side surfaces of the material 1 of the metal mold with such an error abut against the abutting surfaces 2b, 2c, in which state if the lathe-turning is performed in a position where the line L1 as the bisector of the abutting surfaces 2b, 2c intersects the Z-axis, it follows that the lathe-turning is conducted in the position of the transfer surface PL1 or PL3 in FIG. 3(a).

Herein, when lathe-turning, e.g., the transfer surface PL3 at first, the optical axis of the transfer surface PL3 shifts by ΔW outward (rightward in the drawing) in the X-axis direction from the original position and also shifts by ΔW outward (downward in the drawing) in the Y-axis direction. When the lathe-turning is carried out similarly by rotating the material 1 of the metal mold counterclockwise trough 90 degrees, the transfer surface PL4 is formed in the same position (on the Z-axis) with respect to the jig 2, however, the optical axis of the transfer surface PL4 similarly shifts by ΔW outward (rightward in the drawing) in the X-axis direction from the original position and also shifts by ΔW outward (downward in the drawing) in the Y-axis direction. The four transfer surfaces PL1 to PL4 are formed as indicated by solid lines in FIG. 3(a) by iterating the operations described above, at which time an optical axis OA of each transfer surface shifts, as illustrated in FIG. 3(b), radially to a position (OA′) spaced away by √2·ΔW from the design position. The same is applied to a case of performing the lathe-turning in the position of the transfer surface PL1.

Namely, according to the first working mode, if the external dimension of the material 1 of the metal mold is smaller than the design value, the inter-optical-axis pitch of the four transfer surfaces PL1-PL4 becomes as large as P+2ΔW, however, the line connecting the optical axes together is parallel with the original line. In other words, the square formed by connecting the optical axes of the lathe-turned transfer surfaces PL1 to PL4 is concentric with the square formed by connecting the optical axes of the transfer surfaces based on the design value but expands radially corresponding to the error in the external shape.

Hence, in such an application that the lines connecting the optical axes to each other are desired to be kept in parallel with the side surfaces of the material 1 of the metal mold even when the optical axes deviate, this working mode gets effective. The same can be said also in a case where the external dimension of the material 1 of the metal mold is larger than the design value.

(Second Working Mode)

FIG. 4(a) is a view schematically depicting the worked surface of the material 1 of the metal mold, in which the deviation of the transfer surface is illustrated in exaggeration. Similarly to what has been described above, the assumption is that the external dimension W of the material 1 of the metal mold is smaller than the design value, that is, (W−ΔW). Namely, this is a case in which a tolerance of the external dimension is set minus.

The two side surfaces among the side surfaces of the material 1 of the metal mold with such an error abut against the abutting surfaces 2b, 2c, in which state if the lathe-turning is performed in a position where the line L2 orthogonal to the bisector of the abutting surfaces 2b, 2c intersects the Z-axis, it follows that the lathe-turning is conducted in the position of the transfer surface PL2 or PL4 in FIG. 4(a).

Herein, when lathe-turning, e.g., the transfer surface PL4 at first, the optical axis of the transfer surface PL4 shifts by ΔW outward (rightward in the drawing) in the X-axis direction from the original position and also shifts by ΔW outward (downward in the drawing) in the Y-axis direction. When rotating the material 1 of the metal mold counterclockwise trough 90 degrees, as illustrated in FIG. 4(a), the optical axis of the transfer surface PL4 gets directed outward (rightward in the drawing) in the X-axis direction but inward (upward in the drawing) in the Y-axis direction. This point is different from the first working mode. When the lathe-turning is likewise conducted in such a state, the transfer surface PL1 is formed in the same position (on the Z-axis) with respect to the jig 2, however, the optical axis of the transfer surface PL1 similarly shifts by ΔW outward (rightward in the drawing) in the X-axis direction from the original position and also shifts by ΔW outward (downward in the drawing) in the Y-axis direction. The four transfer surfaces PL1 to PL4 are formed as indicated by the solid lines in FIG. 4(a) by iterating the operations described above, at which time the optical axis OA of each transfer surface shifts, as illustrated in FIG. 4(b), by ΔW on the same side in the direction of connecting the two optical axes with respect to the design position but moves on the opposite side in the direction orthogonal thereto up to the position (OA′) shifted by ΔW. The same is applied to a case of performing the lathe-turning in the position of the transfer surface PL2.

That is, according to the second working mode, if the external dimension of the material 1 of the metal mold is smaller than the design value, rotational phases of the optical axes of the four transfer surfaces PL1 to PL4 change counterclockwise on the material 1 of the metal mold, however, the inter-optical-axis pitch P is maintained. Thus, even though the position of the optical axis deviates on the material 1 of the metal mold and if the inter-optical-axis pitch P is maintained, the deviation of the optical axis in the product can be obviated by shifting the rotational phase between the metal molds having a face-to-face relationship when mounting the metal molds in the molding apparatus. The same can be said also in the case where the external dimension of the material 1 of the metal mold is larger than the design value.

It is herein assumed that a first metal mold is manufactured according to the working mode illustrated in FIGS. 4(a) and 4(b). In this connection, a working mode suited for manufacturing a second metal mold having the face-to-face relationship with the first metal mold will be described with reference to FIGS. 4(c) and 4(d). Note that the external dimension W of a material 1″ of the metal mold is assumed to be larger (W+ΔW′) than the design value. Namely, this is a case where the tolerance of the external dimension W is set plus.

The two side surfaces among the side surfaces of the material 1″ of the metal mold having such an error abut against the abutting surfaces 2b, 2c in FIG. 2, in which state if the lathe-turning is performed in a position where the line L2 orthogonal to the bisector of the abutting surfaces 2b, 2c intersects the Z-axis, the lathe-turning is conducted in the position of the transfer surface PL2 or PL4 in FIG. 4(c).

Herein, when lathe-turning, e.g., the transfer surface PL4 at first, the optical axis of the transfer surface PL4 shifts by ΔW′ inward (leftward in the drawing) in the X-axis direction from the original position and also shifts by ΔW′ inward (upward in the drawing) in the Y-axis direction. When rotating the material 1″ of the metal mold counterclockwise trough 90 degrees, as illustrated in FIG. 4(c), the optical axis of the transfer surface PL4 gets directed outward (rightward in the drawing) in the X-axis direction and outward (downward in the drawing) in the Y-axis direction. When the lathe-turning is likewise conducted in such a state, the transfer surface PL1 is formed in the same position (on the Z-axis) with respect to the jig 2, however, the optical axis of the transfer surface PL1 similarly shifts by ΔW′ inward (leftward in the drawing) in the X-axis direction from the original position and also shifts by ΔW′ inward (upward in the drawing) in the Y-axis direction. The four transfer surfaces PL1 to PL4 are formed as indicated by the solid lines in FIG. 4(c) by iterating the operations described above, at which time the optical axis OA of each transfer surface shifts, as illustrated in FIG. 4(d), by ΔW′ on the same side in the direction of connecting the two optical axes with respect to the design position but moves on the opposite side in the direction orthogonal thereto up to the position (OA′) shifted by ΔW′. The same is applied to a case of performing the lathe-turning in the position of the transfer surface PL2.

Thus, if the external dimension of the material 1″ of the metal mold is larger than the design value, unlike the working mode illustrated in FIGS. 4(a) and 4(b), the rotational phases of the optical axes of the four transfer surfaces PL1 to PL4 change clockwise on the material 1 of the metal mold. The inter-optical-axis pitch P is, however, maintained.

Accordingly, when forming the first metal mold from the material 1 of the metal mold and forming the second metal mold from the material 1″ of the metal mold, these metal molds are adjusted in the face-to-face relationship, at which time the optical axes of the four transfer surfaces PL1 to PL4 rotate in the same direction with respect to the design position, and hence the positional adjustments of the metal molds are facilitated. In addition, if an absolute value of a dimensional error (−ΔW) of the first metal mold is equal to an absolute value of a dimensional error (+ΔW′) of the second metal mold, it follows that rotational angles of the optical axes of the four transfer surfaces PL1-PL4 with respect to the design position become coincident with each other in the two metal molds, and there is almost no necessity for adjusting the rotation phases. Furthermore, it is preferable that the external dimensional error ΔW′ of the metal mold is equal to or smaller than ½of the error of the distance (the inter-optical-axis pitch P) between the transfer surfaces.

FIGS. 5 to 7 are views illustrating steps of molding a lens array by use of the metal molds manufactured by the manufacturing method described above. Metal molds 10, 20 are configured by forming the transfer surfaces on the material 1 of the metal mold described above. To be more specific, an undersurface 11 of the upper metal mold 10 is formed with four protruded optical surface transfer surfaces 12 in a 2-row/2-column format according to the working mode described above. A circular stepped portion 13, which is more protruded by one step than the undersurface 11, formed along a periphery of each optical surface transfer surface 12. The upper metal mold 10 can involve using a crustaceous material durable against glass forming, which is exemplified by a hard metal and silicon carbide. Further, this is the same with the lower metal mold 20 which will be described as below.

On the other hand, an upper surface 21 of the lower metal mold 20 is formed with a land 22 taking substantially a square shape, and an flat upper surface 23 of the land 22 is formed with four recessed optical surface transfer surfaces 24 in the 2-row/2-column format according to the working mode described above. Four side surfaces of the land 22 are formed with flat surface portions 25 each inclined at a predetermined angle to the optical axis of each of the surface transfer surfaces 24. The flat surface portion 25 such as this can be formed at the high accuracy by machining that involves using a form cutter etc. Note that a recessed portion for transferring a mark indicating the direction may be formed on the land 22.

At this time, the material 1 of the metal mold manufactured in the second working mode is used as the lower metal mold, and the material 1 of the metal mold that is used for the upper metal mold is manufactured in the second working mode, in which case if the metal mold used as the lower metal mold and a work rotating direction are reversed, the optical surface transfer surfaces 24 are shifted to face each other and thus worked, and therefore highly accurate molding can be attained. Similarly, the highly accurate molding can be attained by reversing the work rotating direction also in the first working mode.

Next, a way of molding the lens array will be described by use of FIGS. 5 to 7. To begin with, as illustrated in FIG. 5(a), the lower metal mold 20 is positioned under a platinum nozzle NZ communicating with a reservoir (unillustrated) of the glass that is molten by heating, liquid droplets of the molten glass GL are dropped batchwise from the platinum nozzle NZ down onto the upper surface 21 in the way of being directed to the position at an equal distance from the plurality of optical surface transfer surfaces 24. In such a state, viscosity of the glass GL is low, and hence the dropped-down glass GL spreads over the upper surface 21 in a way that embraced the land 22, thus transferring a shape of the land 22. In this connection, there is a method of supplying minute liquid droplets by dropping the droplets separately, however, it is desirable in this case that after adjusting a dropping quantity thereof by letting the comparatively large liquid droplets of the glass GL through four small holes, the liquid droplets are thereby separated into four streams of small liquid droplets and thus supplied onto the upper surface 21 almost simultaneously. Note that in the case of dropping down the liquid molten glass, a dead air space is easy to occur between the respective forming surfaces, and hence such a necessity arises as to sufficiently consider dropping conditions of a dropping volume etc.

Subsequently, before the glass GL is cooled, the lower metal mold 20 is made close to a face-to-face position under the upper metal mold 10 in FIG. 5(b) and is thus aligned with the upper metal mold 10. Further, as depicted in FIG. 6, the molding is carried out by making the upper metal mold 10 and the lower metal mold 20 close to each other by employing an unillustrated guide. The optical surface transfer surface 12 and the circular stepped portion 13 of the upper metal mold 10 are transferred onto the upper surface of the thus-flattened glass GL, while the shape of the land 22 of the lower metal mold 20 is transferred onto the undersurface thereof. At this time, the glass GL is cooled while retaining the upper and lower metal molds 10, 20 so that the undersurface 11 of the upper metal mold 10 and the upper surface 21 of the lower metal mold 20 are spaced away at a predetermined distance in parallel. The glass GL gets hardened in a state of transferring the flat surface portion 25 in a wraparound way along the periphery.

Thereafter, as illustrated in FIG. 7, a glass lens array LA1 is formed by taking out the glass GL in a way that separates the upper metal mold 10 and the lower metal mold 20 from each other.

FIG. 8 is a perspective view of the glass lens array LA1 that is transfer-formed by the upper metal mold 10 and the lower metal mold 20. As depicted in FIG. 8, the glass lens array LA1 is a thin square plate on the whole and includes a surface LA1a, four lens elements LA1b that are transfer-formed on the surface LA1a, and side surfaces LA1c surrounding the surface LA1a.

Next, a glass lens array molded separately in the same mode as the glass lens array LA1 is molded, is pasted to the glass lens array LA1, thereby forming an intermediate product IM (see FIG. 9).

Concretely, an UV (ultraviolet) curing bonding agent (unillustrated) is coated over the surfaces of the glass lens arrays LA1, then the surfaces LA1a thereof abut against each other by getting the glass lens arrays LA1 held by two holders HLD (only one holder is depicted in FIG. 9) close to each other with a circular light shielding member SH being interposed therebetween, and ultraviolet rays are irradiated from outside, whereby the glass lens arrays LA1 are bonded together.

Thereafter, the intermediate product IM obtained by pasting the glass lens arrays LA1 together can be removed from the holders HLD by stopping suction of one holder HLD and thus separating the holders HLD from each other, and hence, as depicted in FIG. 9, an image-capturing lens OU as illustrated in FIG. 10 can be acquired by cutting the intermediate product IM with a dicing blade DB. The image-capturing lens OU includes a first lens LS1, a second lens LS2, a rectangular plate-like flange F1 provided along the periphery of the first lens LS1, a rectangular plate-like flange F2 provided along the periphery of the second lens LS2, and the light shielding member SH disposed between the first lens LS1 and the second lens LS. Thereafter, the molded image-capturing lens OU is cleaned, and both surfaces thereof are AR-coated (coated for anti-reflection) by an evaporation machine. Through the operations described above, the highly accurate image-capturing lenses can be massively manufactured.

FIG. 11 is a view illustrating a state where the material 1′ of the metal mold according to another mode is retained on the jig 2 as viewed in the Z-axis direction. According to the present embodiment, a different point is that the material 1′ of the metal mold is composed of a plate member taking an octagonal shape (N=8).

In the present embodiment, the first (n is an integer of 1 through 8) side surface SD1 of the material 1′ of the metal mold abuts against the abutting surface 2b of the jig 2′ in the X-axis direction, a third side surface SD3 of the material 1′ of the metal mold abuts against the abutting surface 2c of the jig 2′ in the Y-axis direction, thereby fixing the material 1′ of the metal mold to the jig 2′. Subsequently, the jig 2′ and the material 1′ of the metal mold are together rotated by an unillustrated lathe, meanwhile the transfer surface (any one of PL2, PL4, PL6, PL8) is formed by cutting the material 1′ of the metal mold, next the material 1′ of the metal mold is rotated stepwise through 45 degrees counterclockwise with respect to the jig 2′, and the steps described above are repeated seven times.

Hereat, in the case of performing the lathe-turning in a position where the line L1 defined as the bisector of the abutting surfaces 2b, 2c intersects the Z-axis, the octagon formed by connecting the optical axes of the transfer surfaces PL1 to PL8 is, though concentric with the octagon formed by connecting the optical axes of the transfer surfaces based on the design value, an octagon spreading radially corresponding to the error of the external shape.

By contrast, in the case of conducting the lathe-turning in a position where the line L2 orthogonal to the bisector of the abutting surfaces 2b, 2c intersects the Z-axis, the pitch of the optical axes of the transfer surfaces PL1 to PL8 is equal to the pitch of the optical axes of the transfer surfaces based on the design value, however, the octagon formed by connecting the optical axes thereof is an octagon of which a rotational phase shifts with respect to the octagon formed by connecting the optical axes of the transfer surfaces based on the design value. Hence, a preferable manufacturing method may be selected depending on the application.

FIG. 12 is an explanatory view of a metal mold manufacturing method according to still another embodiment. In the present embodiment, eight transfer surfaces can be formed on the square-shaped material 1 of the metal mold. At first, in the same way as the embodiment discussed above, as illustrated in FIG. 12(a), the undersurface of the material 1 of the metal mold is made to abut against the retaining surface of the jig, further the side surface SD1 of the material 1 of the metal mold is made to abut against the abutting surface 2b of the X-axis block 2B, and the side surface SD2 of the material 1 of the metal mold is made to abut against the abutting surface 2c of the Y-axis block 2C, whereby the material 1 of the metal mold is retained on the jig 2 by the unillustrated fixing tool. From this state, the first transfer surface PL1 is lathe-turned by rotating the rotary shaft 3 of the lathe.

After finishing lathe-turning the first transfer surface, the material 1 of the metal mold is removed from the jig 2 and rotated counterclockwise (or clockwise) through 90 degrees, the undersurface of the material 1 of the metal mold is thereafter again made to abut against the retaining surface 2a of the body 2A, the side surface SD2 of the material 1 of the metal mold is further made to abut against the abutting surface 2b of the X-axis block 2B, and the side surface SD3 of the material 1 of the metal mold is made to abut against the abutting surface 2c of the Y-axis block 2C, whereby the material 1 of the metal mold is retained on the jig 2 by use of the unillustrated fixing tool. From this state, the second transfer surface PL2 is lathe-turned by rotating the rotary shaft 3 of the lathe. The four transfer surfaces PL1 to PL4 can be formed by iterating the operations described above in the same way as the embodiment discussed above. FIG. 12(a) depicts a state immediately after forming the four transfer surfaces PL1 to PL4.

Subsequently, the material 1 of the metal mold formed with the transfer surfaces PL1-PL4 is replaced on another jig. The new jig is, as illustrated in FIG. 12(b), the same in terms of its shape as the jig depicted in FIG. 12(a) with respect to the Y-axis block 2C but is thinner by a half (P/2) of the inter-optical-axis pitch P of the transfer surfaces PL1 to PL4 with respect to the X-axis block 2B′. It therefore follows that the center O of the rotary shaft 3 is positioned at the center between the optical axes of the transfer surfaces PL4, PL3 (in the state of FIG. 12(a)). Instead of replacing the jig, however, a spacer having a thickness (P/2) may be inserted in between the X-axis block 2B and the material 1 of the metal mold and removed after lathe-turning the transfer surfaces PL1-PL4.

Furthermore, similarly to what has described above, the undersurface of the material 1 of the metal mold is made to abut against the retaining surface of the jig, further the side surface SD1 of the material 1 of the metal mold is made to abut against the abutting surface 2b of the

X-axis block 2B′, and the side surface SD2 of the material 1 of the metal mold is made to abut against the abutting surface 2c of the Y-axis block 2C, whereby the material 1 of the metal mold is retained on the jig 2 by the unillustrated fixing tool. From this state, a fifth transfer surface PL5 is, as indicated by the dotted line, lathe-turned by rotating the rotary shaft 3 of the lathe. The fifth transfer surface PL5 is formed in just a middle position between any two adjacent transfer surfaces (which are herein PL4, PL3) among the transfer surfaces PL1 to PL4.

After finishing lathe-turning the fifth transfer surface, the material 1 of the metal mold is removed from the jig 2 and rotated counterclockwise (or clockwise) through 90 degrees, the undersurface of the material 1 of the metal mold is thereafter again made to abut against the retaining surface 2a of the body 2A, the side surface SD2 of the material 1 of the metal mold is further made to abut against the abutting surface 2b of the X-axis block 2B′, and the side surface SD3 of the material 1 of the metal mold is made to abut against the abutting surface 2c of the Y-axis block 2C, whereby the material 1 of the metal mold is retained on the jig 2 by use of the unillustrated fixing tool. From this state, a sixth transfer surface PL6 is lathe-turned by rotating the rotary shaft 3 of the lathe. In addition to the four transfer surfaces PL1 to PL4 (the solid lines), the four transfer surfaces PL5 to PL8 (the dotted lines) can be formed at the high accuracy by iterating the operations described above.

It will be apparent to those skilled in the art from the embodiments described in the specification and the technical idea that the present invention is not limited to the embodiments described in the specification but embraces other embodiments and modified examples. For example, the material of the metal mold may not take the perfectly equilateral N-angle shape, in which, as illustrated in FIG. 13(a), e.g., a circular arc surface CL (including a shape formed by cutting out the side surfaces SD1 to SD4 out of the circular plate), may establish connections between the adjacent side surfaces SD1 to SD4 of the material 1 of the metal mold, which abut against the reference planes 2b, 2c, and such a shape is also included as to be formed by establishing the connections between the adjacent transfer surfaces PL1 to PL4 of the material 1 of the metal mold, which abut against the reference planes 2b, with a chamfered (bevels) TP. In this case, a shape formed by making extended surfaces (the dotted lines in FIG. 13) intersect each other, into which the side surfaces SD1 to SD4 are extended, becomes the square shape. Moreover, the method of the present invention does not entail forming all of the transfer surfaces of the material of the metal mold, but it is sufficient to form only some of these transfer surfaces.

### DESCRIPTION OF THE REFERENCE NUMERALS AND SYMBOLS

1, 1′, 1″ material of metal mold
2, 2′ jig
2A body
2B X-axis block
2C Y-axis block
2D balancer
2a retaining surface
2b abutting surface in X-axis direction
2c abutting surface in Y-axis direction
3 rotary shaft
4 turning tool
10 upper metal mold
11 undersurface
12 optical surface transfer surface
13 circular stepped portion
20 lower metal mold
21 upper surface
22 land
23 upper surface
24 optical surface transfer surface
25 flat surface portion
DB dicing blade
F1 rectangular plate-like flange
F2 rectangular plate-like flange
GL glass
HLD holder
IM intermediate product
LS1 lens
L1, L2 line
LS2 lens
LA1 glass lens array
LA1a surface
LA1b lens element
LA1c side surface
NZ platinum nozzle
OU image-capturing lens
PL1 to PL4 transfer surface
PL5 to PL8 transfer surface
SD1 to SD4 side surface
SH light shielding member

1. A metal mold manufacturing method of work-forming a plurality of transfer surfaces corresponding to optical surfaces of an optical element by use of a lathe on a material of a metal mold with its external shape being an equilateral N-angle shape (N is an even number equal to or larger than “4”), the material being fitted to a jig including a first reference plane parallel with an axis of rotation of the lathe and a second reference plane parallel with the axis of rotation and extending in a direction intersecting the first reference plane, the method comprising:
a first step of getting an n-th (n is an integer equal to or larger than “1”) side surface of the material of the metal mold to abut against the first reference plane of the jig, getting a (n+k)th (k is an integer equal to or larger than “1”) side surface of the material of the metal mold to abut against the second reference plane of the jig, and thus fixing the material of the metal mold to the jig;
a second step of forming the transfer surface by cutting the material of the metal mold while rotating the jig and the material of the metal mold together by the lathe; and
a third step of forming other transfer surfaces by repeating the first step and the second step in a way that raises the number of n.

2. The metal mold manufacturing method according to claim 1, wherein an optical axis of the first transfer surface to be work-formed at first shifts from a bisection of the first reference plane and the second reference plane of the jig, passes through a center of the equilateral N-angle shape and exists on a line orthogonal to the bisector.

3. The metal mold manufacturing method according to claim 1, wherein the optical axis of the first transfer surface to be work-formed at first exists on the bisection of the first reference plane and the second reference plane of the jig.

4. The metal mold manufacturing method according to claim 1, wherein N=4, and k=1.

5. The metal mold manufacturing method according to claim 1, wherein N=8, and k=2.

6. The metal mold manufacturing method according to claim 1, wherein an error of an external dimension of the metal mold is equal to or smaller than ½ of an error of a distance between the plurality of transfer surfaces.

7. The metal mold manufacturing method according to claim 2, wherein when manufacturing the first metal mold and the second metal mold having a face-to-face relationship with the first metal mold by the manufacturing method, a tolerance of accuracy of the external dimension of the first metal mold is set minus, while the tolerance of accuracy of the external dimension of the second metal mold is set plus.

8. The metal mold manufacturing method according to claim 7, wherein an absolute value of the error of the external dimension of the first metal mold is approximately equal to an absolute value of the error of the external dimension of the second metal mold.
